(19) United States
(12) Patent Application Publication
(10) Pub. No.: US 2025/0135710 A1
(43) Pub. Date: May 1, 2025

(54) CONTROL CIRCUIT FOR CONTAINER COOLING

(71) Applicant: Krones AG, Neutraubling (DE)

(72) Inventor: Ralf URBAN, Teugn (DE)

(21) Appl. No.: 18/926,204

(22) Filed: Oct. 24, 2024

(30) Foreign Application Priority Data
Oct. 25, 2023 (DE) 10 2023 129 375.3

(51) Int. Cl. B29C 49/64; B29C 49/06; B29C 49/42; B29C 49/78; B29K 67/00; B29L 31/00; B67C 3/22

(52) U.S. Cl. CPC B29C 49/6604; B29C 49/06; B29C 49/42412; B29C 49/4281; B29C 49/42824; B29C 49/786; B67C 3/22; B29C 2049/6606; B29C 2049/7867; B29K 2067/003; B29L 2031/712; B67C 2003/227

(57) ABSTRACT

The disclosure relates to a plant for producing and treating containers, comprising: a preform production machine for producing preforms, in particular an injection-molding machine; at least one container production unit for producing containers from the preforms; at least one container treatment unit, arranged downstream of the container production unit, for treating the containers produced in the container production unit; a cooling unit for cooling the containers produced in the container production unit, wherein the cooling unit is arranged downstream of the container production unit, and wherein the cooling unit is configured to cool the produced containers, in particular the bottoms of the produced containers, with a cooling medium as a function of control parameters of the preform production machine and/or as a function of control parameters of the container production unit and/or as a function of the container treatment unit.

### CROSS REFERENCE TO RELATED APPLICATION

The present application claims priority to German Patent Application No. 10 2023 129 375.3 filed on Oct. 25, 2023. The entire contents of the above-listed application are hereby incorporated by reference for all purposes.

### TECHNICAL FIELD

The disclosure relates to a plant and to a method in the food and beverage industry for producing and treating containers in which preforms produced by injection-molding processes or by other processes are formed into containers, e.g., by stretch blow molding.

### BACKGROUND

With known production processes for containers, in particular plastic containers, by stretch blow molding from preforms, the production of the preforms and the production of containers from the preforms are separated in terms of location and time.

### SUMMARY

In this way, for example, the preforms are produced at one location, stored as bulk material, and at a later point in time transported to a container production plant at another location, where they are sorted and separated again and fed to a stretch blow molding machine.

These well-known production processes are logistically very complex, expensive, and susceptible to failure.

In addition, known production processes have a high energy requirement for temperature control, i.e., both for heating and cooling the preforms and containers. Combined with the long transport routes required from preform production to container production, this results in a poor carbon balance for known production processes.

In addition, temperature fluctuations can occur during known production processes, which can have a detrimental effect on the stability and quality of containers made of plastic.

### Object

It is therefore an object of the disclosure to provide an improved plant and an improved method in the food and beverage industry for producing and treating containers made from preforms by means of forming.

In particular, it is an object of the disclosure to provide the efficiency, in particular the energy efficiency, economic efficiency, environmental compatibility, product quality, hygiene, and susceptibility to failure of a plant and a method in the food and beverage industry for producing and treating containers produced from preforms by means of forming.

### Achievement

According to the disclosure, this is achieved by the subject matter as described herein.

In this way, the disclosure provides in particular a plant for producing and treating containers, which can comprise the following components:
a preform production machine for producing preforms, in particular an injection-molding machine,
at least one container production unit for producing containers from the preforms produced by the preform production machine,
at least one container treatment unit, arranged downstream of the container production unit, for treating the containers produced in the container production unit,
at least one cooling unit, in particular a controllable cooling unit, for cooling the containers produced in the container production unit, wherein the at least one cooling unit is arranged downstream of the container production unit, e.g., wherein the at least one cooling unit can be arranged between the container production unit and the container treatment unit, and wherein the cooling unit can be configured to cool, in particular automatically, the produced containers, in particular the bottoms of the produced containers, with a cooling medium as a function of control parameters of the preform production machine and/or as a function of control parameters of the container production unit and/or as a function of the container treatment unit.

The containers and preforms described herein can in particular be understood to mean containers and preforms that consist of material comprising plastic materials, e.g., polyethylene terephthalate (PET), or that consist of plastic materials, e.g., polyethylene terephthalate (PET).

Said exemplary cooling unit can be arranged downstream of the container production unit, e.g., said exemplary cooling unit can be arranged between the container production unit and the container treatment unit, or said exemplary cooling unit can be arranged between two container treatment units.

According to the plant described above and herein, a control circuit, in particular an automated control circuit, for cooling the containers produced in the container production unit, in particular for cooling the bottoms of the produced containers, can be formed or realized, in which control circuit the preform production machine, the at least one container production unit, the at least one container treatment unit, arranged downstream of the container production unit, and the at least one cooling unit can be connected to one another, e.g., can be connected to one another in a block.

This can lead, among other things, to an optimization of the energy efficiency of container production from preforms and, in particular, to an optimized cooling of the containers, in particular the container bottoms, which can have a beneficial effect on the dimensional stability and structural stability of the containers produced. Among other things, insufficient, i.e., too little, bottom clearance of the produced containers can be avoided.

PET containers can be very sensitive to temperature fluctuations, and the cooling control circuits described here can be used to optimally control the temperature of the containers.

The quality of the produced containers can therefore be improved, and the rejection rate of faulty, e.g., unstable, containers can be reduced, and the energy required for cooling the containers, e.g., the energy required for air cooling and/or water cooling, can be reduced.

In addition, by automating the cooling control or the control circuit, less manual intervention or manual adjustment of container cooling systems, in particular container bottom cooling systems, is required, and any cooling failures can be more easily and automatically identified and can be corrected more easily and quickly. This can, among other things, benefit production efficiency.

All of the aforementioned exemplary components of the plant, i.e., the preform production machine, the at least one container production unit, the at least one container treatment unit, arranged downstream of the container production unit, and the at least one cooling unit, can be connected to one another in a block.

By directly linking or connecting the production process for the preforms and the production of containers from the preforms at the same location, it is possible, for example, to significantly reduce or completely eliminate transport and storage costs for the preforms, since the preforms no longer have to be transported over long distances from a plant for producing the preforms to the container production plant.

Said at least one exemplary container treatment unit can be or comprise a labeling machine or a filling machine.

For example, the at least one cooling unit for cooling the containers produced in the container production unit can be arranged directly or indirectly upstream of the at least one container treatment unit for cooling the containers upstream of the labeling machine and/or upstream of the filling machine.

The plant can further comprise a preform treatment unit for treating the containers produced by the preform production machine.

For example, this optional preform treatment unit can be a preform cleaning unit and/or a preform sterilization unit, wherein the preform treatment unit can be arranged upstream of the container production unit.

Said exemplary cooling unit can then, for example, also be configured to cool the produced containers, in particular the bottoms of the produced containers, as a function of control parameters of the preform treatment unit.

Said cooling medium, which can be used by the exemplary cooling unit described above and herein, can be a gaseous cooling medium, e.g., air, and/or the cooling medium can be a liquid cooling medium, e.g., water.

For example, the cooling unit can be constructed as a fan that can blow a gaseous cooling medium, e.g., air, onto or against the containers to be cooled, in particular onto or against the container bottoms to be cooled.

The cooling medium can be directed from the outside against the exterior of the containers to be cooled, in particular against the exterior of the container bottoms to be cooled, e.g., by blowing or spraying.

Said exemplary at least one container production unit for producing containers from the preforms can be a stretch blow molding machine.

Said exemplary cooling unit can then also be configured to cool the produced containers, in particular the bottoms of the produced containers, as a function of the control parameters of the stretch blow molding machine.

For example, said exemplary cooling unit can be configured to cool the produced containers, in particular the bottoms of the produced containers, as a function of one or more or all of the following control parameters of the stretch blow molding machine: pre-blowing pressure, intermediate blowing pressure, final blowing pressure, the time profile of said pressures or the time profile of one or more pressure profiles of said pressures, temperature, control parameters of a heating module of the stretch blow molding machine, control parameters of a cooling module of the stretch blow molding machine.

Said exemplary preform production machine for producing preforms can be an injection-molding machine.

Said exemplary cooling unit can then also be configured to cool the produced containers, in particular the bottoms of the produced containers, as a function of the control parameters of the injection-molding machine.

In particular, the exemplary cooling unit can also be configured to cool the produced containers, in particular the bottoms of the produced containers, as a function of one or more or all of the following control parameters of the injection-molding machine: holding pressure, injection pressure, injection flow, injection profile, temperature, switching volume, or switching point.

In injection molding, the plastic may shrink during cooling. In order to compensate for this shrinkage, material can continue to be pressed into the cavity after volumetric mold-filling. The phase in which the screw continues to apply pressure to the melt is called the holding pressure or holding pressure phase.

Said exemplary container treatment unit can be a filling machine for filling the produced containers.

Said exemplary cooling unit can then also be configured to cool the produced containers, in particular the bottoms of the produced containers, as a function of one or more or all of the following control parameters of the filling machine: filling temperature, filling dosage.

The plant described above and herein by way of example can comprise a higher-level programmable control unit, wherein the control unit can be configured to control and regulate all the machines and units mentioned above and herein of the plant.

In particular, the possible exemplary control unit can be programmed to control said exemplary cooling unit, in particular as a function of said control parameters of the machines and units mentioned above and herein of the plant.

The strength with which the cooling medium can be directed, e.g., blown or sprayed, from the cooling unit against the exterior of the containers to be cooled, in particular against the exterior of the container bottoms to be cooled, can also be determined as a function of the control parameters mentioned above and herein of the machines and units mentioned above and herein of the plant.

An exemplary method for cooling containers made from preforms can comprise the following steps:
cooling containers made from preforms by means of a cooling unit, in particular cooling bottoms of the containers made from preforms, by a cooling medium, e.g., by a gaseous cooling medium, e.g., air, and/or by a liquid cooling medium, e.g., water,
and wherein the cooling is controlled as a function of control parameters of a preform production machine for producing the preforms,
and/or wherein the cooling is controlled as a function of control parameters of a container production unit for producing containers from the preforms,
and/or wherein the cooling is controlled as a function of control parameters of a container treatment unit for treating the containers produced in the container production unit.

In this case, the control of cooling as a function of control parameters can be understood in particular as control in a control loop.

In addition, it is conceivable, for example, for the cooling to be controlled as a function of control parameters of an injection-molding machine for producing the preforms, and/or for the cooling to be controlled as a function of control parameters of a stretch blow molding machine for producing containers from the preforms, and/or for the cooling to be controlled as a function of control parameters of a filling machine for filling the produced containers.

The cooling of the containers, in particular the cooling of the bottoms of the containers, can be carried out by applying the cooling medium to the exterior of the container—for example, by blowing or spraying the cooling medium onto the exterior of the container.

For example, the cooling medium can be a gaseous cooling medium, e.g., air, and can be blown against the exterior of the container, in particular against the exterior of the bottom of the container.

Alternatively or additionally, the cooling medium can be a gaseous cooling medium, e.g., air, and can be blown against the interior of the container, in particular against the interior of the bottom of the container, during the container inflation process.

Alternatively or additionally, the cooling medium can be a liquid cooling medium, e.g., water, and can be sprayed or jetted against the exterior of the container, in particular against the exterior of the bottom of the container.

### BRIEF DESCRIPTION OF THE FIGURES

Further exemplary aspects of the disclosure or exemplary aspects of the claim features are illustrated by way of example by the following figures:

FIG. 1: Exemplary plant

FIG. 2: Exemplary method

### DETAILED DESCRIPTION

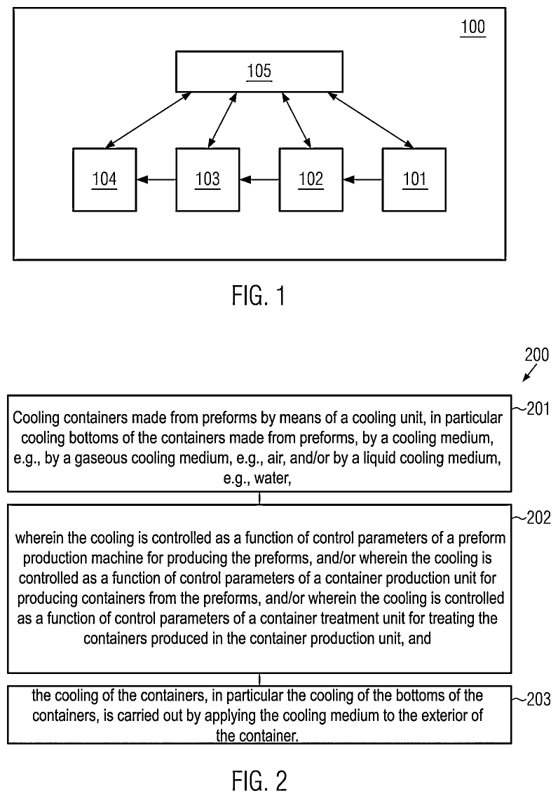

FIG. 1 schematically shows an exemplary plant 100 for producing and treating containers with several machines or units 101, 102, 103, 104.

For example, the plant 100 can have a preform production machine 101 for producing preforms, in particular an injection-molding machine.

Likewise, the plant 100 can comprise a container production unit 102 for producing containers from the preforms, e.g., a stretch blow molding machine.

Likewise, the plant 100 can comprise a container treatment unit 103, arranged downstream of the container production unit 102, for treating the containers produced in the container production unit 102, e.g., a labeling machine, e.g., a container decorating machine with printing or other type of labeling of containers, e.g., with a laser labeling unit or a filling machine.

In addition, the plant 100 can comprise a cooling unit 104 for cooling the containers produced in the container production unit 102, wherein the cooling unit 104 is arranged, for example, downstream of the container production unit 102.

In the example shown, the cooling unit 104 is arranged downstream of the container treatment unit 103. However, it can also be arranged, for example, upstream of the container treatment unit 103.

The exemplary cooling unit 104 can be configured to cool the containers produced in the container production unit 102, in particular the bottoms of the produced containers, with a cooling medium as a function of control parameters of the preform production machine 101 and/or as a function of control parameters of the container production unit 102 and/or as a function of the container treatment unit 103.

A possible higher-level programmable control unit 105 of the plant 100 is also shown by way of example, wherein the control unit can be configured to control and regulate machines and units 101, 102, 103, and 104 of the plant 100.

In particular, the possible exemplary control unit 105 can be programmed to control said exemplary cooling unit 104, in particular as a function of said control parameters of the machines and units 101, 102, 103, 104 mentioned above and herein of the plant 100.

The machines and units 101, 102, 103, and 104 of the plant 100 can be connected to one another in a block.

FIG. 2 shows an exemplary schematic flow diagram for an exemplary method 200 for cooling containers made from preforms, which can comprise the following steps:
cooling 201 containers made from preforms by means of a cooling unit, in particular cooling bottoms of the containers made from preforms, by a cooling medium, e.g., by a gaseous cooling medium, e.g., air, and/or by a liquid cooling medium, e.g., water,
and wherein the cooling is controlled 202 as a function of control parameters of a preform production machine for producing the preforms,
and/or wherein the cooling is controlled 202 as a function of control parameters of a container production unit for producing containers from the preforms,
and/or wherein the cooling is controlled 202 as a function of control parameters of a container treatment unit for treating the containers produced in the container production unit,
and wherein the cooling of the containers, in particular the cooling of the bottoms of the containers, is carried out by applying 203 the cooling medium to the exterior of the container.

In this case, the control of cooling as a function of control parameters can be understood in particular as control in a control loop.

FIG. 1 and FIG. 2 follow.

The reference signs are assigned as follows:
100 exemplary plant for producing and treating containers
101 preform production machine
102 container production unit
103 container treatment unit
104 cooling unit
105 control unit
200 exemplary method for cooling containers made from preforms
201 method step
202 method step
203 method step

1. A plant for producing and treating containers, comprising:
a preform production machine for producing preforms;
at least one container production unit for producing containers from the preforms;
at least one container treatment unit, arranged downstream of the container production unit, for treating the containers produced in the container production unit;
a cooling unit for cooling the containers produced in the container production unit, wherein the cooling unit is arranged downstream of the container production unit; and
wherein the cooling unit is configured to cool the produced containers, with a cooling medium as a function of control parameters of the preform production machine and/or as a function of control parameters of the container production unit and/or as a function of the container treatment unit.

2. The plant according to claim 1, wherein the container treatment unit is a labeling machine.

3. The plant according to claim 1, wherein the plant further has a preform treatment unit for treating the containers produced by the preform production machine, wherein the preform treatment unit is arranged upstream of the container production unit, and wherein the cooling unit is configured to cool the produced containers as a function of control parameters of the preform treatment unit.

4. The plant according to claim 1, wherein the cooling medium is a gaseous cooling medium.

5. The plant according to claim 1, wherein the cooling medium is a gaseous cooling medium and wherein the cooling unit is constructed as a fan.

6. The plant according to claim 1, wherein the at least one container production unit for producing containers from the preforms is a stretch blow molding machine, and wherein the cooling unit is configured to cool the produced containers as a function of control parameters of the stretch blow molding machine.

7. The plant according to claim 6, wherein the cooling unit is configured to cool the produced containers as a function of one or more or all of the following control parameters of the stretch blow molding machine: pre-blowing pressure, final blowing pressure, intermediate blowing pressure, time profile of the pressures, temperature, control parameters of a heating module of the stretch blow molding machine, control parameters of a cooling module of the stretch blow molding machine.

8. The plant according to claim 1, wherein the preform production machine for producing preforms is an injection-molding machine, and wherein the cooling unit is configured to cool the produced containers as a function of the control parameters of the injection-molding machine.

9. The plant according to claim 7, wherein the cooling unit is configured to cool the produced containers as a function of one or more or all of the following control parameters of the injection-molding machine: holding pressure, injection pressure, injection flow, injection profile, temperature.

10. The plant according to claim 1, wherein the container treatment unit is a filling machine for filling the produced containers, and wherein the cooling unit is configured to cool the produced containers as a function of one or more or all of the following control parameters of the filling machine: filling temperature, filling dosage, filling pressure, pre-tensioning time, relief time, pressure profile of the filling, filling temperature.

11. The plant according to claim 1, comprising a higher-level programmable control unit, wherein the control unit is configured to control and regulate all the machines and units of the plant.

12. A method for cooling containers made from preforms, comprising:
cooling containers made from preforms by means of a cooling unit by a cooling medium,
and wherein the cooling is controlled as a function of control parameters of a preform production machine for producing the preforms, and/or wherein the cooling is controlled as a function of control parameters of a container production unit for producing containers from the preforms, and/or wherein the cooling is controlled as a function of control parameters of a container treatment unit for treating the containers produced in the container production unit.

13. The method according to claim 12, wherein the cooling is controlled as a function of control parameters of an injection-molding machine for producing the preforms, and/or wherein the cooling is controlled as a function of control parameters of a stretch blow molding machine for producing containers from the preforms, and/or wherein the cooling is controlled as a function of control parameters of a filling machine for filling the produced containers.

14. The method according to claim 12, wherein the cooling of the containers is carried out by applying the cooling medium to the exterior of the container.

15. The method according to claim 14, wherein the cooling medium is a gaseous cooling medium; and/or wherein the cooling medium is a gaseous cooling medium.

16. The plant according to claim 1, wherein the preform production machine is an injection-molding machine.

17. The plant according to claim 1, wherein the cooling unit is configured to cool the bottoms of the produced containers.

18. The method according to claim 14, wherein the cooling medium is air and is blown against the outside of the container, including against the outside of the bottom of the container.

19. The method according to claim 14, wherein the cooling medium is air, and is blown against the inside of the container, including against the inside of the bottom of the container, during the container inflation process.
